(19) United States
(12) Patent Application Publication
(10) Pub. No.: US 2012/0230783 A1
(43) Pub. Date: Sep. 13, 2012

(54) Auxiliary Hand Grip for Rasp

(76) Inventor: Jeremy C. Johns, Charlestown, NH (US)

(21) Appl. No.: 13/406,671

(22) Filed: Feb. 28, 2012

Related U.S. Application Data
(60) Provisional application No. 61/451,156, filed on Mar. 10, 2011.

(51) Int. Cl. B23D 71/10

(52) U.S. Cl. 407/29.15

(57) ABSTRACT

The auxiliary hand grip attaches to a conventional rasp to provide the user with an additional grip, allowing the user to better control the rasp when used to reconfigure a hoof. The auxiliary hand grip has a plate affixed to a socket element, the socket element extending along an axis and the plate extending substantially normal to the axis. The socket has inner surfaces spaced to accept a distal end extension of the rasp, and is aligned with the rasp so as to align the axis of the auxiliary hand grip with a longitudinal axis of the rasp. Clamping elements such as set screws extending through the socket serve to affix the auxiliary hand grip onto the distal end extension of the rasp.

### FIELD OF THE INVENTION

The present invention provides an auxiliary grip that attaches to a rasp such as used for contouring the hooves of horses to provide the user increased control of the rasp.

### BACKGROUND OF THE INVENTION

Rasps that are employed for contouring the hooves of horses have a longitudinal axis, a distal end extension, and a proximal end extension. The proximal end extension is configured to be readily mounted in any of various currently available handles, such handles having a handle axis that is aligned with the rasp axis when the handle is mounted onto the proximal end extension. The distal end extension is typically bounded by an extension upper surface and an extension lower surface which are each substantially planar and have a distal end extension width W, these surfaces being parallel to each other and separated to define a distal end extension thickness t. Both the distal end and the proximal end extensions generally have smooth surfaces so that the rasp can be gripped by the user's hands without requiring handles to be installed. In general, a central region between the extensions is rectangular in cross section, having four raised surfaces forming the abrading surfaces of the rasp. These abrading surfaces are used to contour the hooves of horses that are being prepared for re-shoeing.

A variety of proximal end handles are currently available to allow the user to provide power strokes to abrade the hoof surface and reconfigure it. The control of the stroke can be enhanced if the distal end of the rasp can be controlled to avoid wandering during the power strokes. Currently, this control is frequently supplied by gripping the distal end extension. While it is helpful in controlling movement of the rasp, the ability to grip the distal end extension is limited to finger contact and frequently results in the fingers being engaged with one or more of the abrading surfaces of the rasp. This problem has been addressed, in part, my providing a polymer cover into which the distal end extension slips; when in place, the cover also covers part of the raised abrasive surfaces to allow firmer gripping of the distal end extension by the fingers and to protect the fingers from accidental contact with the abrading surfaces. These covers reduce the discomfort that can result from gripping the distal end extension by eliminating the user contact the roughened section of the rasp, and allowing the finger tips of the user to be more securely engaged with respect to the rasp. However, the control of the distal end of the rasp is still controlled by fingertip contact which does not provide particularly positive control.

### SUMMARY OF THE INVENTION

The auxiliary hand grip of the present invention provides a grip configured to allow the user to wrap the fingers about the auxiliary hand grip as well as to allow the grip to be engaged by a portion of the palm of the hand; such engagement allows the user to more firmly engage the distal end extension, thereby providing better control of the rasp against torsional loads introduced when using the rasp to reconfigure a hoof and allowing the user to grasp the distal end of the rasp with various hand and finger positions to apply force as desired. Furthermore, the increased engagement allows the user to apply a pulling force with the hand engaging the distal end extension, allowing the user to perform power strokes while resting the hand engaging the conventional handle mounted to the proximal end extension.

The auxiliary hand grip has a auxiliary hand grip axis and a plate bounded by a peripheral edge disposed about the distal grip axis. This plate extends substantially normal to the auxiliary hand grip axis.

Attached to the plate is a socket element having a socket upper surface and a socket lower surface which extend parallel to each other and to the grip axis. The socket upper and lower surfaces are spaced apart by a socket depth D that is at least as great as the extension thickness t of the distal end extension so as to accommodate at least a portion of the distal end engaged in the socket. The socket element can be formed as a rectangular tube having a tube passage bounded by a passage upper surface and a passage lower surface, which serve as the socket upper and lower surfaces, and passage side surfaces. The tube passage is aligned with the auxiliary hand grip axis. The tube passage is configured to accommodate the rasp distal end extension such that one of the extension upper surface and the extension lower surface can be placed in slidable contact with one of the passage upper surface and the passage lower surface.

Means for aligning the auxiliary hand grip axis with the rasp axis when inserting the distal end extension into engagement with the socket element can be provided to assure that, when the one of the extension upper or lower surfaces is in slidable contact with the corresponding socket surface, the axes are aligned. When the socket element is formed by a rectangular tube, the separation of side surfaces of the resulting rectangular passage can be closely matched to the distal end extension width W of the of the rasp to provide this means. In any case, for greatest stability, the socket surfaces can be separated such that the socket depth D is only slightly greater than the extension thickness t such that both the upper and lower surfaces are slidably engaged.

Clamping means are provided, which are associated with the socket element and serve to affix the socket element to the distal end extension of the rasp. Typically, such clamping means are provided by one or more threaded elements that can be tightened to clamp the socket element against a portion of the distal end extension. When the socket element is provided by a rectangular tube, it can be provided with at least one setscrew that threadably engages the rectangular tube to provide the clamping means. The at least one setscrew passes through a passage surface so as to be forcibly engagable with the distal end extension when the setscrew is threadably advanced. In a preferred embodiment, the setscrew(s) pass through the upper or lower surface of the rectangular passage.

### BRIEF DESCRIPTION OF THE FIGURES

FIG. 1 is a partially exploded isometric view of one embodiment of a auxiliary hand grip for a rasp, the grip having a plate and a rectangular tube attached thereto to provide a socket element. The grip is illustrated adjacent to a portion of a rasp which includes a rasp distal end extension, which is positioned to be inserted into a tube passage of the auxiliary hand grip.

FIG. 2 is an isometric view of the auxiliary hand grip shown in FIG. 1 with the rasp distal end extension inserted into the tube passage of the auxiliary hand grip and secured thereto by setscrews that threadably engage the rectangular tube.

FIGS. 3 and 4 illustrate the auxiliary hand grip shown in FIGS. 1 and 2 when employed to provide a grip for a rasp having a narrower width. To stabilize the narrower rasp, a pair of spacers are employed that fill the space between the edges of the distal end extension of the rasp and side surfaces of the tube passage. FIG. 3 illustrates auxiliary hand grip prior to insertion of the rasp and spacers into the tube passage, while FIG. 4 shows the auxiliary hand grip installed on the distal end extension of the rasp.

FIG. 5 is an exploded isometric view that illustrates a auxiliary hand grip similar to that shown in FIGS. 1-4, but differing in the details of its construction. In this embodiment, the rectangular tube is formed by machining a block and is attached to the grip with screws.

FIG. 6 is an isometric view of a more basic embodiment of a auxiliary hand grip, having a plate with a rectangular central section and a socket element formed by a U-shaped channel. The socket element is clamped onto the distal end extension of the rasp by bolts that serve both to close the sides of the socket element to provide stability and to clamp the socket element to the rasp.

### DETAILED DESCRIPTION

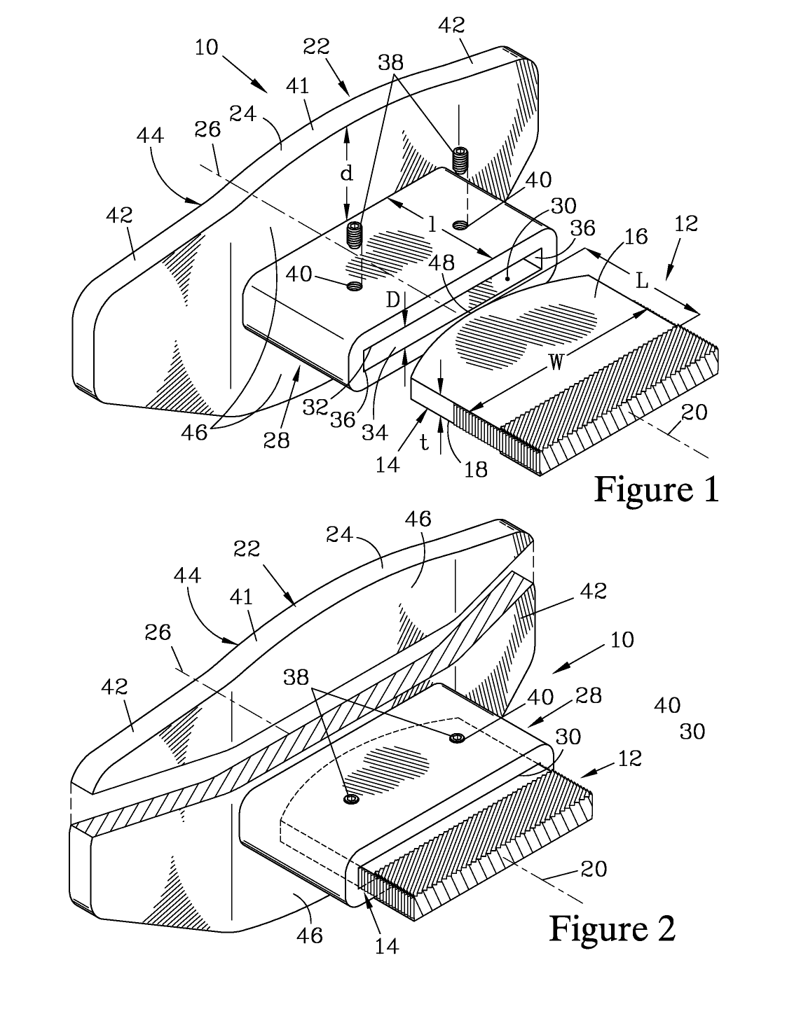

FIG. 1 is a partially exploded isometric view of a auxiliary hand grip 10 for a rasp 12, the auxiliary hand grip 10 forming one embodiment of the present invention. The auxiliary hand grip 10 is configured to engage a distal end extension 14 of the rasp 12. This distal end extension 14 is bounded in part by an extension upper surface 16 and an extension lower surface 18, each having an extension width W. These extension surfaces (16, 18) are parallel and spaced apart so as to provide an extension of thickness t. The rasp 12 has a longitudinal rasp axis 20, about which the rasp 12 is symmetrically located.

The auxiliary hand grip 10 has a plate 22 bounded by a peripheral edge 24 that is preferably symmetrically disposed about a auxiliary hand grip axis 26 that is normal to the plate 22. Having the peripheral edge symmetrical allows the user to readily grasp the rasp 12 either upright in the orientation illustrated or inverted relative to the illustrated position so as to use either of the active surfaces of the rasp 12.

A rectangular tube 28 is attached to the plate 22 to serve as a socket element for engaging the rasp 12. The rectangular tube 28 has a tube passage 30 extending along the auxiliary hand grip axis 26 and bounded by a passage upper surface 32 and a passage lower surface 34 spaced apart by a separation D, and a pair of passage side surfaces 36. The size of the passage 30 is sufficiently large to accommodate the insertion of the rasp distal end extension 14 thereinto.

Two set screws 38 are provided, which threadably engage threaded screw passages 40 provided in the rectangular tube 28 and provide clamping means to affix the socket element to the distal end extension 14 of the rasp 12. In this embodiment, the screw passages 40 pass through the upper surface 32 of the tube passage 30 so as to forcibly engage the extension upper surface 16 when the distal end extension 14 is inserted into the tube passage 30 and the setscrews 38 are advanced in the screw passages 40, as shown in FIG. 2.

The plate 22 is formed with a planar central section 41, which extends normal to the grip axis 26, and a pair of plate wings 42 which are canted with respect to the auxiliary hand grip axis 26 so as to form a concave terminating free surface 44 of the plate 22, as best shown in the sectioned view of FIG. 2; while the plate could be formed with a continuous concave curve, providing the planar central section 41 facilitates attachment of the rectangular tube 28 thereto, such as by welding when the plate 22 and the rectangular tube are made from a suitable metal such as aluminum or brass. The plate wings 42 aid the user in gripping the auxiliary hand grip 10 so as to better stabilize the rasp 12 in service, and help to contour the plate 22 so as to be firmly grasped by the user in a variety of hand and finger positions. The ability to grasp the plate 22 is further enhanced by forming the peripheral edge 24 of the plate 22 such that the central section has bowed edges that create a width that decreases as it approaches the wings 42, this taper in the edges continuing in the wings 42.

The plate 22, as configured and positioned, provides overhanging regions 46 above and below the rectangular tube 28. These regions 46 each have a maximum depth d and provide surfaces which can be employed to engage a portion of the palm of a user in service, thereby serving to further stabilize the rasp 12 in service and allowing the user to forcibly apply the rasp 12 against a hoof by pulling the rasp with the hand engaging the auxiliary hand grip 10 or by pushing from the distal end. Having the auxiliary hand grip 10 so configured not only allows the hand to guide the rasp distal end extension 14, but also to pull it forward with the hand thereby reducing the force needed to be applied to the proximal end extension with the other hand and thus allowing both hand so share in applying the motivating force to the rasp.

To provide means for aligning the rasp axis 20 with the distal end axis 26 as the distal end extension 14 is inserted into the passage 30 of the tube 28, it is preferred for the passage side surfaces 36 to have a separation essentially the same as or only slightly greater than the extension width W. It is also preferred for the tube passage 30 to have a passage length l that is less than an extension length L of the distal end extension 14, thereby allowing a distal end terminal surface 48 (shown in FIG. 1) of the rasp 12 to rest against the plate 22 when the distal end extension 14 is fully inserted into the tube passage 30.

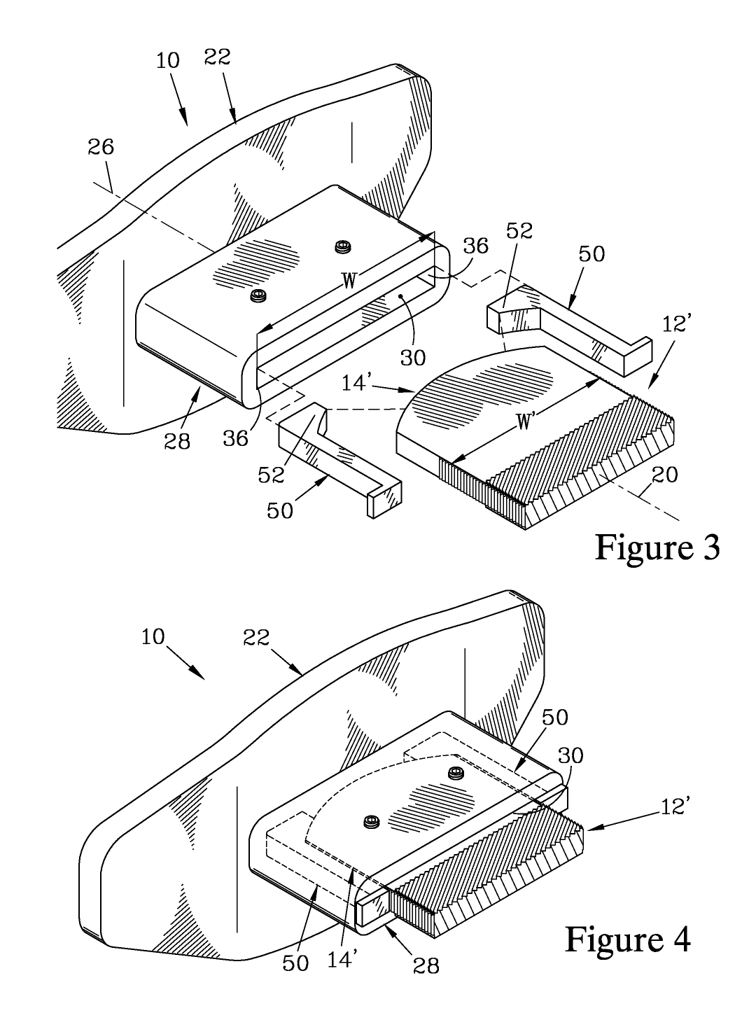

FIGS. 3 and 4 illustrate a pair of spacers 50 that can be employed with the auxiliary hand grip 10 when used with a rasp 12′ having a somewhat narrower extension width W′ that is significantly less than the separation between the passage side surfaces 36, which is essentially the same as the extension width W of the wider rasp 12 shown in FIGS. 1 and 2. The spacers 50 are provided with insertion hooks 52 that engage the distal end extension 14′ to maintain the spacers 50 engaged therewith as the distal end extension 14′ is inserted into the tube passage 30.

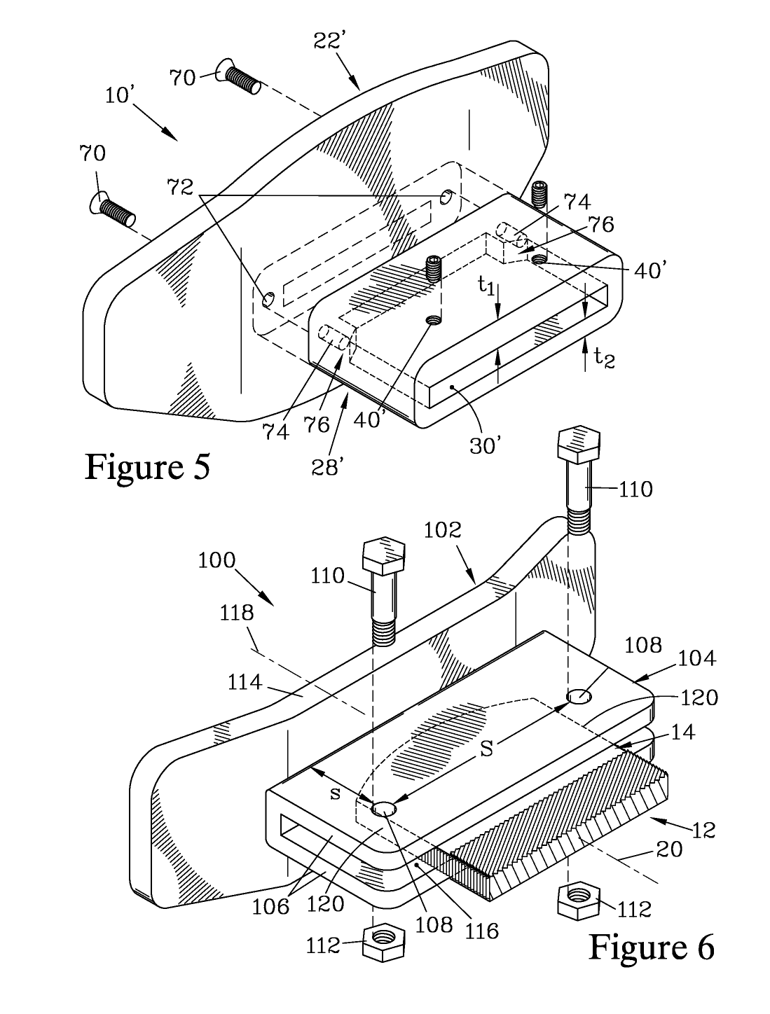

While the grip 10 shown in FIGS. 1-4 can be readily formed by welding a length of suitably-sized rectangular tube stock onto a plate that is bent to provide a concave terminating surface, alternative fabrication techniques could be employed. As an example of such, FIG. 5 illustrates a auxiliary hand grip 10′ which is functionally similar to the grip 10, but differs in the details of its construction. In the grip 10′, a plate 22′ is affixed to a rectangular tube 28′ by screws 70 that pass through plate passages 72 in the plate 22′ and threadably engage recesses 74 formed in the rectangular tube 28′. To accommodate the recesses 74, the rectangular tube 28′ is formed by machining a solid block of material to form a tube passage 30′ while leaving remaining a pair of corner blocks 76, into which the recesses 74 are formed.

When the rectangular tube 28′ is formed by machining, it may be desirable to form the tube passage 30′ off-center so as to provide a greater thickness t₁ on the side in which the screw passages 40′ are provided compared to the thickness t₂ of the other side to increase the depth of screw passages 40′ passing therethrough.

FIG. 6 illustrates an alternative embodiment for a auxiliary hand grip 100 that may offer greater ease of fabrication, since it does not require that a rectangular tube be provided; however, may or may not have the self-aligning properties provided by the earlier described embodiment. The grip 100 has a plate 102 that is affixed to a socket element 104 that, in the grip 100, is formed as a U-shaped channel that provides a pair of parallel socket plates 106 for engaging the distal end extension 14 of the rasp 12. The socket plates 106 are each provided with a pair of bolt passages 108 through which clamp bolts 110 pass. The socket element 104 can be affixed to the distal end extension 14 by tightening the clamp bolts 110 by use of nuts 112, the combined nuts bolts 110 and nuts 112 serving as clamping elements to bring the socket plates 106 into forcible engagement with the distal end extension 14 to affix the grip 100 thereto.

The socket element 104 can be affixed to the plate 102 by suitable means, such as by being welded to a central section 114 of the plate 102. Forming the socket element 104 as a U-shaped channel results in greater ease in affixing the socket plates 106 to the plate 102 than if the socket plates were provided as individual elements. However, because the socket element 104 has open sides that are closed only by the clamp bolts 110, the sides of a socket 116 formed by these elements may not be stabilized sufficiently to provide means for positively aligning a grip axis 118 with the rasp axis 20. However, if a bolt separation S between the clamp bolts 110 when installed in the bolt passage 108 is maintained at only slightly greater than the distal end width W, and a bolt spacing s from the plate 102 is sufficiently large to assure that the clamp bolts 110 are positioned to bracket side surfaces 120 of the rasp extension 14, then the clamp bolts 110 will serve to, in part, align the grip axis 118 with the rasp axis 20.

While the novel features of the present invention have been described in terms of particular embodiments and preferred applications, it should be appreciated by one skilled in the art that substitution of materials and modification of details can be made without departing from the spirit of the invention.

1. An auxiliary hand grip for a rasp, the rasp having, a rasp longitudinal axis,
a distal end extension bounded by an extension upper surface and an extension lower surface which are each substantially planar having a width W, these surfaces being parallel to each other and separated to define an extension thickness t, and
a proximal end extension suitable for mounting in a handle,
the auxiliary hand grip comprising:
a plate bounded by a peripheral edge disposed about a grip axis extending substantially normal to said plate;
a socket element attached to said plate, said socket element having a socket upper surface and a socket lower surface that are parallel to each other and spaced apart so as to accommodate at least a portion of the rasp distal end extension therebetween with one of the extension upper surface and the extension lower surface slidably contacting one of said socket upper surface and said socket lower surface; and
clamping means associated with said socket element and activatable to affix said socket element to the distal end extension of the rasp.

2. The auxiliary hand grip of claim 1 further comprising:
means for aligning the grip axis with the rasp axis when inserting the distal end extension into engagement with said socket element.

3. The auxiliary hand grip of claim 2 wherein said socket element further comprises:
a rectangular tube having a tube passage bounded by a passage upper surface and a passage lower surface, which respectively provide said socket upper surface and said socket lower surface, and a pair of opposed passage side surfaces, said tube passage extending along the grip axis and being further configured to accommodate the rasp distal end extension with one of the extension upper surface and the extension lower surface slidably contacting one of said passage upper surface and said passage lower surface.

4. The auxiliary hand grip of claim 3 wherein said clamping means are provided by:
at least one threaded passage extending through said rectangular tube so as to terminate at said passage upper surface; and
at least one setscrew threadably engaged in said threaded passage so as to be advancible therethrough so as to become forcibly engaged with the extension upper surface.

5. The auxiliary hand grip of claim 4 wherein the distal end extension of the rasp has an extension length L and said tube passage has a passage length l, wherein L>l,
further wherein said upper and lower passage surfaces are separated by a passage depth D which is slightly greater than the extension thickness t such that said tube passage is slidably engagable with the distal end extension.

6. The auxiliary hand grip of claim 1 wherein said plate is configured to create a concave terminal surface for the auxiliary hand grip facing away from said socket element.

7. (canceled)

8. The auxiliary hand grip of claim 5 wherein said means for aligning the grip axis aligned with the rasp axis is provided by said passage side surfaces.

9. The auxiliary hand grip of claim 5 wherein means for aligning the grip axis further comprises:
spacers for positioning between each of passage side surfaces and the distal end extension.

10. The auxiliary hand grip of claim 1 wherein said plate has overhanging regions residing above and below said socket element.

11. The auxiliary hand grip of claim 5 wherein said plate has overhanging regions residing above and below said socket element.
